(19) United States
(12) Patent Application Publication
(10) Pub. No.: US 2025/0091908 A1
(43) Pub. Date: Mar. 20, 2025

(54) METHOD TO GENERATE VIGOROUS CAVITATION THROUGH THE MICROSCALE DEVICE AT LOW PRESSURE FOR WASTEWATER TREATMENT

(71) Applicants: Dmitry GRISHENKOV, Huddinge (SE); SABANCI UNIVERSITESI NANOTEKNOLOJI ARASTIRMA VE UYGULAMA MERKEZI, Istanbul (TR); SABANCI UNIVERSITESI, Istanbul (TR)

(72) Inventors: Dmitry GRISHENKOV, Huddinge (SE); Farzad Rokhsar TALABAZAR, Istanbul (TR); Ali KOSAR, Istanbul (TR); Araz Sheibani AGHDAM, Istanbul (TR); Morteza GHORBANI, Istanbul (TR)

(73) Assignees: Dmitry GRISHENKOV, Huddinge (SE); SABANCI UNIVERSITESI NANOTEKNOLOJI ARASTIRMA VE UYGULAMA MERKEZI, Istanbul (TR); SABANCI UNIVERSITESI, Istanbul (TR)

(21) Appl. No.: 18/729,522

(22) PCT Filed: Jul. 6, 2022
(86) PCT No.: PCT/TR2022/050709

§ 371 Date: Jul. 17, 2024

(51) Int. Cl. C02F 1/34; C02F 101/34; C02F 101/36; C02F 101/38

(52) U.S. Cl. CPC C02F 1/34; C02F 2101/34; C02F 2101/36; C02F 2101/38; C02F 2101/40; C02F 2209/03

(57) ABSTRACT

A method for generating vigorous cavitation through the microscale device at low pressure for wastewater treatment is provided. Specifically, a hydrodynamic cavitation reactor is provided, including at least one inlet port, at least one inlet channel, at least one microchannel, at least one extension channel, at least one outlet channel, at least one outlet port, and at least one pressure port.

### CROSS REFERENCE TO THE RELATED APPLICATIONS

This application is the national phase entry of International Application No. PCT/TR2022/050709, filed on Jul. 6, 2022, the entire contents of which are incorporated herein by reference.

### TECHNICAL FIELD

The present invention relates to a method for generating vigorous cavitation through the microscale device at low pressure for wastewater treatment.

### BACKGROUND

Cavitation defines as the explosive growth and collapse of bubble nuclei in a liquid when exposed to a high-pressure gradient. In this phenomenon, cavitation bubbles start to grow when the fluid's static pressure is decreased below the saturation vapor pressure of the liquid at the operating temperature. Hydrodynamic cavitation (HC) includes a progressive cycle of the nucleation, growth, and implosion of bubbles. The bubbles collapse releases a large amount of energy into the surrounding, leading to the creation of the supercritical region with pressure up to 1000 MPa and the temperature up to 5000 K. These conditions cause the decomposition of the water molecules to the hydroxyl radicals and hydrogen peroxide. Accordingly, each cavitation bubble becomes a micro/nanoreactor to produce highly reactive free radicals and interact with the other components inside the liquid area.

Cavitation is one of the Advanced Oxidation Processes (AOPs) initiated without extra chemical components or initiators. The HC, in contrast to Acoustic Cavitation (AC), works with low energy consumption and generates intensified cavitating flows. Therefore, the implosion of the facile HC releases more radicals in the aqueous medium, and the efficiency of the oxidation process increases at a considerable rate.

There are different approaches in literature and industry to increase the HC oxidation process efficiency. In this regard, all the presented methods are the HC combined to the advanced oxidation process. Various researchers provide the methods in which HC coupled with one of the existing AOPs such as H₂O₂, O₃, Fenton's reagents, and photocatalysis. These combined methods improve the oxidation efficiency in terms of the increase in OH radicals' generation and their effective distribution. However, all these methods utilize the HC as an auxiliary technique for conventional AOP methods. The conventional AOP methods utilize the highly reactive chemical oxidant, which leads to increased toxicity and byproduct released during the oxidation process. In addition, the used chemicals in AOPs are expensive, increasing the oxidation process cost and requiring a long time to eliminate the targeted components. The present process provides the AOP based on an HC reactor without any additive chemicals.

Moreover, some researchers have also provided methods to combine the HC with other techniques such as acoustic cavitation (AC) and ultraviolet irradiation. In these two methods, the AC is utilized as an auxiliary method to increase the intensity of the cavitation. The AC techniques consume a lot of energy with limited penetration depth and fewer cavitation events for generating cavitation bubbles. Ultraviolet irradiation is used as a source of energy to increase the Oxidation Process; this technology consumes a massive amount of energy. Therefore, there are various problems in the scale-up and integration of these systems.

US2013248429A1 describes a device for purifying water includes: a reactor housing having an inlet opening for supplying polluted water and an outlet opening for draining the purified water from the reactor housing; hydrodynamic cavitation means arranged in the reactor housing for causing cavitation in the polluted water; main light means for irradiating the polluted water with ultraviolet light, wherein the main light means to provide a polychromatic and/or monochromatic pulsed ultraviolet light, which is synchronized selectively with the specific cavitation event(s) in the polluted water. The hydrodynamic cavitation means comprises at least one venturi and/or at least one orifice plate having a plurality of holes. This device is coordinated by ultraviolet light for irradiating polluted water.

CN111825202A discloses a device for treating antibiotic wastewater by the combination of hydrodynamic cavitation and oxidation comprises a rotor, a stator, and a center shaft; the stator is a closed cylinder, the rotor is a hollow cylinder, the rotor is arranged in the stator, and ball-column-shaped blind holes are distributed in the outer wall of the rotor; the center shaft is vertically mounted in the stator, penetrates through the stator and the rotor and is fixedly connected with the rotor, a wastewater inlet pipe is arranged at the upper part of the stator, and a wastewater outlet pipe is arranged at the bottom; and an oxidant adding pipe is arranged at the wastewater inlet pipe. Hydrogen peroxide is added to the antibiotic wastewater, the rotor rotates to cavitate the antibiotic wastewater, and the oxidant can degrade part of antibiotics, so that the removal efficiency is improved. The antibiotic wastewater is treated through the combination of hydrodynamic cavitation and oxidation, the antibiotic removal rate is high, the effect is good, and secondary pollution is avoided. This device is coordinated by the oxidant for purifying water.

Farzad Rokhsar Talabazar et al. [1] previous study discloses a new generation of ‘cavitation-on-a-chip’ devices with eight parallel structured microchannels. This new device is designed with the motivation of decreasing the upstream pressure (input energy) required for facile hydrodynamic cavitation inception. However, the present invention differs from the device disclosed in this document in terms of technical differences of HC microreactor such as its size, surface functionalization, and modification. In this HC reactor, the roughness elements in micro and nanoscale are applied to the surface of the reactor which, supplies facile cavitating flow patterns leading to intensive bubble collapse conditions. Hence, this study in contrast to the presented work in the published article considers the potential of the surface roughness on providing more energy release from the collapse of the cavitation bubbles. Therefore, this invention has the capability of treating microorganisms and inorganic substances with enormous energy from the rupture of the bubbles which, is not the case exhibited in the published article.

### SUMMARY

Inspired by the need for highly efficient reactors the HC reactor is developed on a microscale in the proposed invention to be used in the tertiary step of the wastewater treatment and enhanced with surface engineering science to facilitate intense and controlled bubble collapse. The tertiary step is the last step of the wastewater treatment process—after preliminary, primary, and secondary steps—in which, the disinfection of the microorganisms such as bacteria, viruses, algae, and pharmaceuticals ingredients are taken place.

The current invention aims to exploit the chemical effects of the bubble collapse during the HC on a chip process in a highly efficient way for the oxidation process. The oxidation process is enhanced by increasing the bubble generation intensity (according to our recent study [1]) and accelerating the targeted chemical components' interaction with released radicals in a microscale reactor. These chemical targets are the materials, which categorized as hazardous materials which have a negative effect on humans and nature.

The presented invention aims to produce the oxidation agents using a novel approach via the HC on-chip phenomenon.

The free radicals' releases rate is improved through the surface modification of the HC reactor and utilization of microfluidics potential. The presented microfluidic device consists of the multi-parallel micro-orifice and micro ventures as constriction for the generation of the micro-scale cavitation. These constrictions provide the required pressure gradient for bubble generation on a microscale. Moreover, according to the scale effect, the cavitation is generated at low upstream pressure, in other words, the cavitation occurs by consumption of low energy in comparison with conventional size cavitation reactors.

The surface functionalization in the micro/nanoscale is applied in the design and fabrication of the device. These modifications accelerate the intensity of bubble generation and implosion cycle to release more oxidation radical agents. Thus, the oxidation process will be accelerated and controlled in a desirable direction according to the oxidation targets. Our recent study illustrates that it is possible to generate facial cavitating flow in multiple parallel microchannels [1]. In the present invention, It is demonstrated that, in addition to generating an intense cavitating flow pattern, the surface roughness implementations can control the bubble collapse and hence manipulate the chemical effects of the bubble collapse which can be harvested in the tertiary treatment, more specifically in the active pharmaceutical ingredients (APIs) removal. Our preliminary results confirm that even at a very short treatment period and a low number of treatment cycles, the HC on a chip concept reinforced by the surface modifications is very effective in the removal of the targeted pharmaceutical substances compared to the available methodologies.

The novel and unique design of the current invention causes the reduction in the required upstream pressure for cavitation. Thus, the oxidation process through this device initiates and progresses with low energy consumption. The cavitation bubbles collapsed at low upstream pressures indicating the oxidation process will be done by low energy consumption compared with the conventional types of HC reactors. In another word, through the presented method and device, efficient advanced oxidation can be achieved by low energy consumption. The cavitation phenomenon typically happens at high pressures i.e., above 50 bars in the regular microfluidic devices which we have been already fabricated using silicon and glass wafers. However, in this invention, thanks to the surface roughness modifications the cavitation phenomenon occurs at pressures below 10 bars which means that lower energy is consumed in order to generate cavitation bubbles.

Cavitation intensity is the dominant parameter in the oxidation process. In this regard, the implemented surface modification increases the intensity of the cavitation collapse. Thus, the oxidation reaction is increased as well. Moreover, the relation between surface elements, upstream pressure, and generated cavitation intensity presents the correlation to control the HC-induced oxidation process via the physical properties of the reactor and operation conditions. The preliminary results indicate that the invention device and method effectively can eliminate and reduce the existing hard degradable pharmaceuticals components inside the wastewater. The pharmaceutical residues in sewage are categorized as contaminants of emerging concern (CEC). These materials cause ecological and human health impacts. In this regard, different methods are developed recently to treat these kinds of components from the aqua systems. AOP is one of the well-known of these methods, which is initiated by adding the chemical oxidization to begin the process. in this regard, through this method and device, the enhanced advanced oxidation process is initiated without any requirement of extra chemical components by the release of the OH free radicals and hydroxyls. The AOPs are utilized to oxidation the hard degradable parts and the elements with low concentrations. Thus, to comprehensively treat the CECs, the required chemicals are in high concentration, which leads to increased toxicity of the treated water and production materials. However, in the presented method and device, the oxidation process is done when the released radicals contact the components. When there are no chemical components to react with the radicals, these oxidation agents come together and form the water molecule again. Thus, the toxicity of the water body is not increasing, likewise the chemical oxidation process.

Moreover, the utilized chemicals in conventional AOP methods are costly and require considerable energy for production. However, this invention doesn't need extra energy. In this regard, the method and device can be categorized as a green oxidation process that is environmentally friendly.

### BRIEF DESCRIPTION OF THE DRAWINGS

FIGS. 1A-1B: FIG. 1A is the conceptual schematic of the HC reactor a-Cavitation bubbles, b-larger Cavitation bubbles, c-Unstable bubble, d-Critically unstable bubble, e-Collapsed bubble; FIG. 1B is the sequence of a cavitation bubble collapse.

FIG. 2: The surface texture manifestation to be used on the surface of the microchannels.

FIG. 3: Schematic presentation of the treatment process in HC reactor.

FIG. 4: The concentration of the target materials after treatment using HC reactor.

### DEFINITIONS OF THE COMPONENTS/PARTS/PIECES THAT MAKE UP THE INVENTION

1—Inlet port
2—Inlet channel
3—Microchannel
4—Surface roughness element
5—Sidewall roughness element
6—Extention channel
7—Outlet channel
8—Outlet port
9—Pressure port

### DETAILED DESCRIPTION OF THE EMBODIMENTS

The present invention relates to a HC reactor and a method for generating vigorous cavitation through the microscale device at low pressure for wastewater treatment.

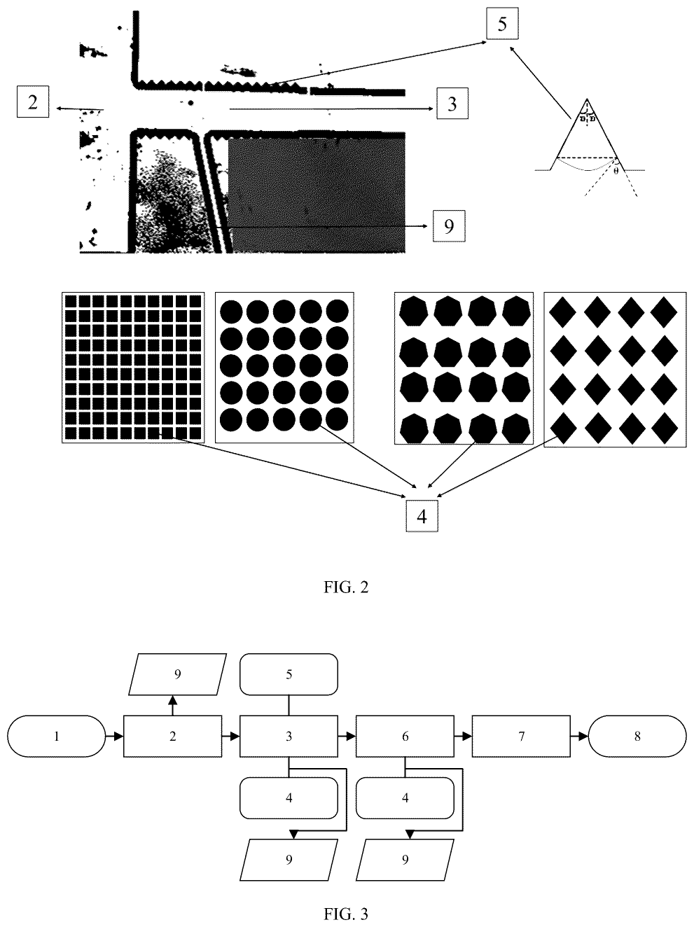

The flow is entered into the hydrodynamic cavitation reactor via inlet port (1) and introduced to the microchannel (3) using Inlet channel (2) which is equipped with sidewall roughness element (5). The collapse of the cavitation bubbles is taken place in the microchannel (3) and extension channel (6). The treated flow is directed toward outlet port (8) using outlet channel (7). Pressure is measured through the pressure port (9). FIG. 2 provides the insight view and component description in at least one microchannel. FIG. 3 presents the schematic of the treatment process as an overview through the HC reactor and its components.

The surface roughness element (4) is deposited on the surface of the HC reactor to intensify the collapse of the cavitation bubbles and increase the released energy.

The sidewall roughness element (5) supplies the intensified cavitating flow patterns. The invention was developed based on a previous study on the cavitation on-chip concept [1]. The significant parts of our research group studies are dedicated to investigating the HC characterization on the microscale. The physical aspects of HC on-chip are investigated regarding the feasibility of the cavitation occurrence and development on a microscale. The presented invention can be categorized as an advanced oxidation process in the mean of efficiency and effectiveness.

The invention technology is intensifying the chemical effects of the bubble collapse via surface modifications of the HC reactor (and the invention design is providing the package of the micro-reactors on a lab on chip concept to increase the oxidation process by decreasing the reaction chambers size). For that aim, the miniaturized physical constrictions are fabricated (in the microscale) to provide the required pressure variation in the flow direction. The HC reactor is designed in a multiple reactor and venturi to cover the high flow rates to scale up for industrial applications. For that aim, the sidewalls of the reactor are equipped with roughness elements, which are patterned on the sidewalls of the HC reactor in various configurations and sizes for generating intensified cavitation flows. In addition to the sidewall roughness implementation, in the present invention, the reactor surface is modified and enhanced by applying the surface roughness and functionalization such as nanoparticles, nano grass, and micro pilar deposition to provide artificial nucleation sites for bubble collapse control and intensifications and functional groups. In addition, the surface wettability was controlled by texture patterns made by coating and nanostructure fabrication in this invention.

Therefore, the current invention is a new method to generate intense bubble collapse through the microscale device with low upstream pressure. The generated bubbles size, nucleation intensity, bubbles coalescence, and the formed vapors controlled through the functionalized device (and the length of the microchannel area). These characteristics lead to control the oxidation process in the mean of the reaction kinetics to achieve the advanced oxidation process. In this regard, the invention method and device can be applied to oxidize and eliminate the chemical components inside the aqueous environment. Therefore, due to the high rate of radical release through this invention, the hard degradable components with low concentration can be oxidized. The presented invention also can be utilized as a homogenizer to increase the solubility of the desirable materials inside the liquids.

The present invention consists of different elements which the interaction between them proposed the novel system to increase the oxidation process efficiency through the HC reactor.

Device design: The HC reactor is designed on a microscale to increase the system's efficiency through the scale effect. Miniaturization maximizes the device performance in the mean of the cavitation generation. In addition, the desirable modification and manipulation can be achieved on the device.

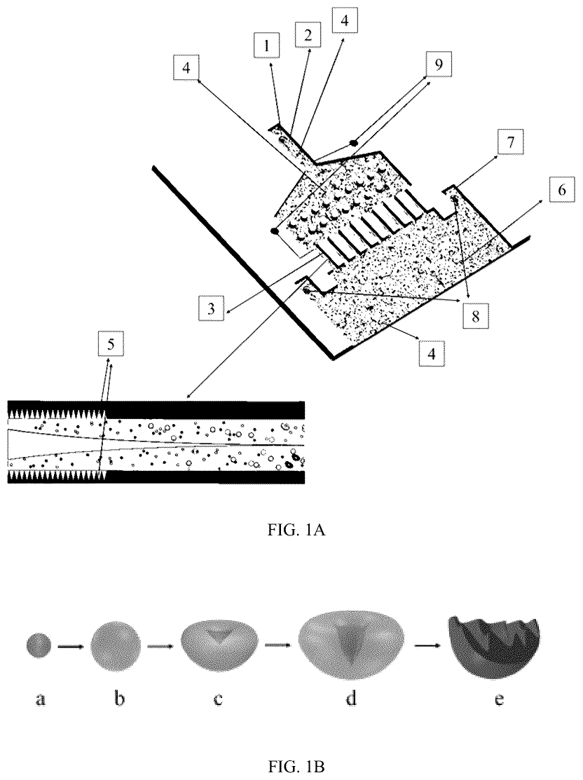

The HC reactor geometry consists of three regions: the inlet, microchannel, and extension. These three areas provide the required pressure gradient for bubble nucleation, growth, and implosion cycles. FIG. 1A shows components of HC reactor.

Hydrodynamic cavitation reactor comprises:
At least one inlet port (1) for supplying working fluid and at least one outlet port (8) for draining the working fluid from the reactor housing;
At least one microchannel (3) in which cavitation occurs for fluid flow in fluid communication with said inlet channel (2) and extension channel (6);
Inlet channel (2) connecting said inlet port (1) respectively, to said microchannel (3);
Outlet channel (7) connecting said outlet port (8) respectively, to said extension channel (6);
At least one pressure port (9) for measuring the pressure of the working fluid constructed and arranged for selective communication with Inlet channel (2), microchannel (3), and extension channel (6);
At least one extension channel (6) connecting said Outlet channel (7), to said microchannel (3);
At least one type of surface roughness element (4) on the surface of the Inlet channel (2), microchannel (3), extension channel (6), and Outlet channel (7);
At least one type of sidewall roughness element (5) on the walls of microchannel (3).

Wherein, surface roughness of the hydrodynamic cavitation reactor for facilitating the cavitation inception provided by deposition of the surface roughness element (4) is selected between nanoparticles, nano grass, and micro pilar on hydrodynamic cavitation reactor and sidewall roughness of the hydrodynamic cavitation reactor is on the wall of the microchannel (3) provided by the engraving of sidewall roughness element (5) to reduce the inception pressure of the cavitation on hydrodynamic cavitation reactor.

In general, the bubbles nucleation starts at the microchannel area (Vena Contracta region: the flow achieves the maximum velocity). The static pressure suddenly falls and starts to grow until it reaches pressure recovery near the extension region. The surface nuclei play a more active role in microscale cavitation compared with macroscale. In this regard, surface modification at the microscale cavitation is a powerful approach to manipulate the phenomenon. We have already discussed the surface effects on the generation of different flow patterns in our recent study [1] and in this invention the surface effects are presented as a strong tool for the vigorous bubble collapse and chemical effect intensification.

The device is equipped with as artificial nucleation sites for bubble nucleation and nano grass surface roughness for the bubble collapse. The size and length of the roughness are determined according to the device geometry, particularly the micro-orifice/venturi width and length. The roughness elements effects are:
Reduce the required upstream pressure for cavitation generation.
Control the bubble generation intensity.
Element's size has dominated role in bubble size and their collapse capacity.
The length of the roughened parts and size have active roles in bubble departure, coalescence, and collapse.
The surface roughness has significant role in the bubble implosion collapse.
The chemical effects of the bubble collapse reinforced by the surface modifications have higher capability in the degradation of the APIs.

Accordingly, the amount of the released oxidation agents can be controlled by controlling the bubbles nucleation intensity and cavitating flow patterns. In general, the oxidation process as a chemical reaction can be controlled and manipulated by implementation of the nano grass surface roughness. Moreover, the surface's wettability is modified to develop the bubble departure rate and control the collapse and coalescences of the bubbles which is presented in this invention for the first time.

The device is designed and fabricated in multi parallel reactor/venturi to increase the inlet flowrate. The microfluidic HC reactor with a high flow rate is developed for industrial applications. Moreover, the device and method can be easily integrable into existing treatment and refinery plants to increase the system's efficiency or add new steps/applications. This device and methodology were also developed as a single platform that can be utilized in mentioned applications.

### Preliminary Results:

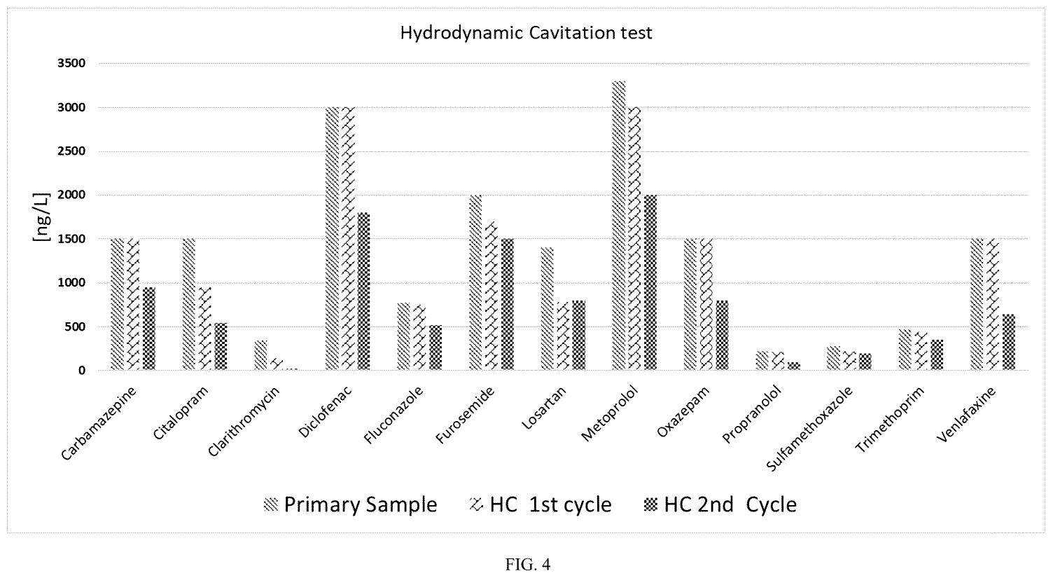

Experiments are carried out on the targets selected according to the WHO and EU commission list of priority substances that require decreasing and removing from the water. In this regard, Carbamazepine, Citalopram, Clarithromycin, Diclofenac, Fluconazole, Furosemide, Losartan, Metoprolol, Oxazepam, Propranolol, Sulfamethoxazole, Trimethoprim, and Venlafaxine are selected as targets. The experiments are conducted to decrease the concentration of each residue under the standard values. The preliminary experiments are performed on these residues, which shows in table 1 and FIG. 4. These results indicate that the microfluidic device (Single orifice HC reactor without surface modification) has significant effects on the mean of pharmaceutical degradation. The volumetric flow rate of the HC reactor is adjusted with inlet pressure; the flow rate will be increased by raising the upstream pressure to achieve the real flow rate in a pilot WWTP. Moreover, favorable cavitating flow patterns that cause high free radical liberation in water emerge at relatively low upstream pressure. Increasing the upstream pressure results in the formation of the supercavitation, which is not the desirable pattern for the oxidation process due to low radical's liberation rates.

The primary experiments are conducted on the wastewater obtained from the real influent of the wastewater treatment plan. The pharmaceutical residues concentrations are in the actual range, which is found in common Sweden cities wastewaters. The pharmaceutical residues concentrations are evaluated after each HC cavitation cycle.

TABLE 1
The variation in the concentration of the targets after the HC treatment

| | Primary Concentration | 1st cycle | 2nd cycle |
|---|---|---|---|
| Substance | [ng/L] | [ng/L] | [ng/L] |
| Carbamazepine | 1500 | 1500 | 950 |
| Citalopram | 1500 | 950 | 540 |
| Clarithromycin | 340 | 140 | 22.5 |
| Diclofenac | 3000 | 3000 | 1800 |
| Fluconazole | 770 | 750 | 520 |
| Furosemide | 2000 | 1700 | 1500 |
| Losartan | 1400 | 780 | 800 |
| Metoprolol | 3300 | 3000 | 2000 |
| Oxazepam | 1500 | 1500 | 800 |
| Propranolol | 220 | 210 | 98 |
| Sulfamethoxazole | 280 | 220 | 190 |
| Trimethoprim | 470 | 440 | 350 |
| Venlafaxine | 1500 | 1500 | 640 |

Accordingly, the results indicate that a considerable amount of the pharmaceutical residues (known as hard degradable components) are oxidized and eliminated in each cycle. Moreover, it is worth mentioning that the primary concentrations of these components are very low. This treatment efficiency demonstrates that the presented invention has a high potential in advanced oxidation without applying any auxiliary treatment step such as chemicals, UV, and other sources of energy and catalysis.

These results are very promising compared to the available studies in the literature, which demonstrates the effectiveness of developed cavitating flows and microscale configuration that our reactors pose (Table 2). The experiments were conducted at constant upstream pressure and temperature of 3 bar and 21° C., respectively, and the sample was treated for only 10 seconds. The results were compared with the literature studies based on the residues removal efficiency, concentrations, and applied method conditions. The experiments were conducted on a sample prepared with a realistic concentration of the substances (according to the real WWTP effluents). The treatment time is another critical parameter; the experiments' duration is almost 6 seconds in the current study. This parameter is one of the important sides of our experiments which shows superiority in comparison to other mentioned studies. Overall plain HC reactor is shown more than 44% average degradation rate in a very short time for mixed pharmaceutical residues. The primary results indicate the feasibility of this reactor for implementation as a new treatment method.

TABLE 2
The comparison of the current invention with the existed technologies

| | Initial | treated | | | | Treatment | Operation | | |
|---|---|---|---|---|---|---|---|---|---|
| | concentration | concentration | Efficiency | | Auxullary | time | temperature | | |
| Pharmaceutical | [ng/L] | [ng/L] | [%] | Method | Oxidant | minute | [° C.] | Energy | References |
| Carbamazepie | 360 | 190 | 47.2 | Microchannel | — | 0.1 | 21 | | Current |
| | | | | HC | | | | | study |
| | 10⁷ | 6.1 × 10⁶ | 38.7 | — | — | 120 | 35 | 0.0303 | [2] |
| | | | | | | | | kWh | |
| | 1000 | — | 56 | Shear HC + | H₂O₂ | 15 | 50 | — | [3] |
| | | | | AOP | [340 | | | | |
| | | | | | mg/L] | | | | |
| | 1-50000 | — | 27 | HC | — | 60 | 25 | — | [4] |
| Diclofenac | 760 | 360 | 52.6 | Microchannel | — | 0.1 | 21 | — | Current |
| | | | | HC | | | | | study |
| | 8-11000 | — | 53 | Venturi HC | UV | 60 | 19 | — | [5] |
| | 2 × 10⁷ | — | 21 | Venturi HC | — | 120 | 35 | 90 W | [6] |
| Fluconazole | 250 | 110 | 56 | Microchannel | — | 0.1 | 21 | — | Current |
| | | | | HC | | | | | study |
| Propranolol | 360 | 190 | 47.2 | Microchannel | — | 0.1 | 21 | — | Current |
| | | | | HC | | | | | study |
| | 60-638 | 7570 | −50, −44 | Real WWTP | — | 600 | 21 | — | [7] |
| Metoprolol | 870 | 390 | 55.1 | Microchannel | — | 0.1 | 21 | — | Current |
| | | | | HC | | | | | study |
| | 2 | — | 99 | Real WWTP | — | 680 | 25 | — | [8] |
| Sulfamethoxazole | 89 | 38 | 57.3 | Microchannel | — | 0.1 | 21 | — | Current |
| | | | | HC | | | | | study |
| | 10⁸ | — | 20 | HC | — | 60 | 55 | 60 | [9] |
| | | | | | | | | W/L | |
| Venlafaxine | 480 | 130 | 72.9 | Microchannel | — | 0.1 | 21 | — | Current |
| | | | | HC | | | | | study |
| | 4 × 10⁸ | 2 × 10⁸ | 50 | Electro | — | 3 (reaction | 55 | — | [10] |
| | | | | peroxone- | | time) | | | |
| Trimethoprim | 130 | 70 | 46.1 | Microchannel | — | 0.1 | 21 | — | Current |
| | | | | HC | | | | | study |
| | — | — | 69.44 | Sonochemistry | — | 120 | — | — | [11] |
| Oxazepam | 320 | 160 | 50 | Microchannel | — | 0.1 | 21 | — | Current |
| | | | | HO | | | | | study |
| Citalopram | 290 | 110 | 62 | Microchannel | — | 0.1 | 21 | — | Current |
| | | | | HC | | | | | study |
| Furosemide | 520 | 310 | 40.3 | Microchannel | — | 0.1 | 21 | — | Current |
| | | | | HC | | | | | study |

### REFERENCES

[1] Rokhsar Talabazar, F., Jafarpour, M., Talebian Gevari, M., Zuvin, M., Chen, H., Villanueva, L. G., Grishenkov, D., Kosar, A., and Ghorbani, M., “Design and Fabrication of a Vigorous “Cavitation on a Chip” Device with Multiple Microchannel Configurations,” Microsystems & Nanoengineering, 7, 1-13, 2021.
[2] P. Thanekar, M. Panda, and P. R. Gogate, “Degradation of carbamazepine using hydrodynamic cavitation combined with advanced oxidation processes,” Ultrason. Sonochem., vol. 40, no. June 2017, pp. 567-576, 2018.
[3] M. Zupanc et al., “Shear-induced hydrodynamic cavitation as a tool for pharmaceutical micropollutants removal from urban wastewater,” Ultrason. Sonochem., vol. 21, no. 3, pp. 1213-1221, 2014.
[4] P. Braeutigam, M. Franke, R. J. Schneider, A. Lehmann, A. Stolle, and B. Ondruschka, “Degradation of carbamazepine in environmentally relevant concentrations in water by Hydrodynamic-Acoustic-Cavitation (HAC),” Water Res., vol. 46, no. 7, pp. 2469-2477, 2012.
[5] M. Zupanc et al., “Removal of pharmaceuticals from wastewater by biological processes, hydrodynamic cavitation and UV treatment,” Ultrason. Sonochem., vol. 20, no. 4, pp. 1104-1112, 2013.
[6] M. V. Bagal and P. R. Gogate, “Degradation of diclofenac sodium using combined processes based on hydrodynamic cavitation and heterogeneous photocatalysis,” Ultrason. Sonochem., vol. 21, no. 3, pp. 1035-1043, 2014.
[7] M. Gardner et al., “Performance of UK wastewater treatment works with respect to trace contaminants,” Sci. Total Environ., vol. 456-457, pp. 359-369, 2013.
[8] E. Vulliet and C. Cren-olive, “Screening of pharmaceuticals and hormones at the regional scale, in surface and groundwaters intended to human consumption,” Environ. Pollut., vol. 159, no. 10, pp. 2929-2934, 2011.
[9] E. R. Bandala, “On the Nature of Hydrodynamic Cavitation Process and Its Application for the Removal of Water Pollutants,” no. 1, pp. 1-6, 2019.
[10] X. Li et al., “Electro-peroxone treatment of the antidepressant venlafaxine: Operational parameters and mechanism,” J. Hazard. Mater., vol. 300, pp. 298-306, 2015.
[11] E. A. Serna-galvis, A. M. Botero-coy, D. Martinez-pach, A. Moncayo-lasso, M. Ib, and R. A. Torres-palma, “Degradation of seventeen contaminants of emerging concern in municipal wastewater effluents by sonochemical advanced oxidation processes,” Water research 54, pp. 349-360, 2019.

What is claimed is:

1. A hydrodynamic cavitation reactor comprising:
at least one inlet port for supplying a working fluid,
at least one inlet channel,
at least one extension channel,
at least one microchannel, wherein a cavitation occurs in the at least one microchannel for a fluid flow in a fluid communication with the at least one inlet channel and the at least one extension channel,
at least one outlet channel,
at least one outlet port for draining the working fluid from a reactor housing,
at least one type of surface roughness element selected between nanoparticle, nano grass, and micro pilar on the hydrodynamic cavitation reactor on a surface of the at least one inlet channel, the at least one microchannel, the at least one extension channel, and the at least one outlet channel,
at least one type of a side wall roughness element on a wall of the at least one microchannel, at least one pressure port for measuring a pressure of the working fluid constructed and arranged for a selective communication with the at least one microchannel, the at least one inlet channel, and the at least one extension channel, wherein
the at least one inlet channel is configured to connect the at least one inlet port to the at least one microchannel,
the at least one outlet channel is configured to connect the at least one outlet port to the at least one extension channel, the at least one extension channel is configured to connect the at least one outlet channel to the at least one microchannel.

2. The hydrodynamic cavitation reactor according to claim 1, wherein a number of the at least one microchannel is equal to or greater than two.

3. The hydrodynamic cavitation reactor according to claim 2, wherein the at least two microchannels are parallel to each other.

4. A method of treating a wastewater, comprising using the hydrodynamic cavitation reactor according to claim 1.

5. The method according to claim 4, wherein the hydrodynamic cavitation reactor is used to eliminate and reduce existing degradable pharmaceuticals components inside the wastewater.

6. A method for increasing an intensity of a hydrodynamic cavitation of the hydrodynamic cavitation reactor according to claim 1, comprising:
i. applying the at least one type of surface roughness element selected between the nanoparticle, the nano grass, and the micro pilar to provide artificial nucleation sites for a bubble collapse control and intensifications on the cavitation,
ii. engraving of the sidewall roughness element on the wall of the at least one microchannel on the hydrodynamic cavitation reactor.

7. The method according to claim 6, wherein the cavitation is carried out at a pressure of lower than 10 bar.
